(19) United States
(12) Patent Application Publication
(10) Pub. No.: US 2020/0004882 A1
(43) Pub. Date: Jan. 2, 2020

(54) MISINFORMATION DETECTION IN ONLINE CONTENT

(71) Applicant: Microsoft Technology Licensing, LLC, Redmond, WA (US)

(72) Inventors: Priyanka Subhash KULKARNI, Bellevue, WA (US); Ruben Tigranovich AGHAYAN, Seattle, WA (US); Lifu HUANG, Bellevue, WA (US); Sachin GUPTA, Remond, WA (US)

(21) Appl. No.: 16/019,898

(22) Filed: Jun. 27, 2018

(51) Int. Cl. G06F 17/30; G06F 17/27; G06F 15/18; G06F 17/18

(52) U.S. Cl. CPC G06F 17/30867; G06F 17/30887; G06Q 50/01; G06F 15/18; G06F 17/18; G06F 17/2785

(57) ABSTRACT

Techniques are presented for providing misinformation detection in online content. The described techniques can identify instances of misinformation in online content and pass a misinformation result to the user. A misinformation probability analysis can be performed by applying a syntactic analysis and a semantic analysis to detect misinformation with confidence by applying featurization to a URL, text of content referenced by the URL, and metadata associated with the URL using a feature set, the feature set comprising semantic-based features and syntactic-based features, wherein the semantic features and the syntactic features are selected from the group consisting of: sentiment amplifiers, sentiment continuity disruption features, lexical features, keywords, baseline features, speech act, sensicon features, emotion detection on the obtained text, exaggerated language, strong adjectives, heuristics, bag-of-words, objectivity, colloquial-ness score, and semantic difference.

### BACKGROUND

The topic of “fake news”, generally defined as false stories—or misinformation—that appear to be news, and which are spread on the Internet or across other media, has come to the forefront of public debate. In some cases, misinformation is used to draw traffic to a site and increase online advertising revenue. In some cases, misinformation is used by hostile actors for political or financial gain or disruption. In some cases, misinformation is spread as a joke. Users have a hard time knowing what content to trust as “real news”.

### BRIEF SUMMARY

Techniques are presented for providing misinformation detection in online content. The described techniques incorporate machine and hybrid intelligence implementing both semantic analysis and syntactic analysis.

In some cases, for misinformation detection in online content, a URL to content can be received, and in response to receiving the URL, text from content referenced by the URL and metadata associated with the URL can be obtained. One or more determinations may be carried out before performing machine/hybrid intelligence activities for misinformation detection to minimize use of computational and network resources. For example, the URL or the content can be analyzed to determine if the URL or content was previously received A series of determinations may be carried out as part of this analysis. For example, a determination can be made of whether the URL is from a distrusted domain. If the URL is from a distrusted domain, a misinformation notification can be provided to a source of the request without performing machine intelligence activities. If the URL is not from a distrusted domain, a determination of whether the URL is a previously received URL can be made. If the URL is a previously received URL, cached information of the previously received URL can be provided from a data resource (and thus also avoid having to perform the machine intelligence activities). If the URL is not a previously received URL, a determination can be made as to whether the content referenced by the URL is a duplicate content. If the content referenced by the URL is the duplicate content, cached information of a URL referencing the duplicate content can be provided from the data resource (and thus also avoid having to perform the machine intelligence activities).

If the content referenced by the URL is not the duplicate content, a misinformation probability analysis of the URL, obtained text, and the metadata associated with the URL can be performed using a feature set at a misinformation probability service (e.g., implementing machine/hybrid intelligence activities). The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and then provided.

The described techniques can identify instances of misinformation in an article and pass this information to the user. The user can then make an informed decision about the article and, if necessary, read it with a more critical eye. Censorship and blocking articles are not goals of the described techniques. Because the misinformation determination of an article can be ambiguous, the user can receive confidence ratings about the determination. For example, the user can be informed with high, medium, or low confidence that an article contains misinformation. Additionally, the category of misinformation can be given to the reader where applicable. For example, an article containing misinformation could be one or more of the following: hyperpartisan, clickbait, satire, rumor mill or a collection of other subcategories of misinformation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which certain implementations of the techniques described herein for misinformation detection in online content may be practiced.

FIG. 2 illustrates an example process for misinformation detection in online content.

FIGS. 3A and 3B illustrate an example scenario of performing misinformation detection in a social media application.

FIGS. 4A-4C illustrate example scenarios of performing misinformation detection at a search engine.

FIGS. 5A and 5B illustrate an example scenario of performing misinformation detection in an email application.

FIGS. 6A and 6B illustrate an example scenario of performing misinformation detection at an article website.

FIGS. 7A and 7B illustrate an example scenario of performing misinformation detection at an article website.

FIG. 8 illustrates components of a computing device that may be used in certain implementations described herein.

FIG. 9 illustrates components of a computing system that may be used to implement certain methods and services described herein

### DETAILED DESCRIPTION

Techniques are presented for providing misinformation detection in online content. The described techniques incorporate machine and hybrid intelligence implementing both semantic analysis and syntactic analysis.

“Machine intelligence,” refers to computer processes involving machine learning, neural networks, or other application of artificial intelligence.

“Hybrid intelligence,” also referred to as hybrid-augmented intelligence, refers to the combination of human and machine intelligence, where both human and machine intelligence are used to address a problem. The hybrid intelligence can be used to train the machine intelligence.

“Misinformation” refers to false or inaccurate information, especially that which is deliberately intended to deceive. News articles containing misinformation are news articles that have been constructed with the intent to deceive or an ulterior motive. One way of looking at this is “fake news” versus not “fake news.” The techniques described herein are directed to identifying content that have a likelihood of being stories with the intent to misinform as opposed to misprints or errors.

Categories of misinformation include, but are not limited to, satire, extreme bias, conspiracy theory, rumor mill, state-sponsored news, junk science, hate news, clickbait, politically motivated, and hyperpartisan.

The described techniques can identify instances of misinformation in online content and pass this information to the user. The user can then make an informed decision about the article and, if necessary, read it with a more critical eye. Censorship and blocking articles are not goals of the described techniques. Because the misinformation determination of an article can be ambiguous, the user can receive confidence ratings about the determination. For example, the user can be informed with high, medium, or low confidence that an article contains misinformation. Additionally, the category of misinformation can be given to the reader where applicable. For example, an article containing misinformation could be one or more of the following: hyperpartisan, clickbait, satire, rumor mill or a collection of other subcategories of misinformation.

Some solutions related to misinformation detection involve a computation intensive fact checking. This is the process of isolating claims made in an article, cross-referencing them to a source of ground truth, and rating the claims as true or false. Based on the ratings of the constituent claims, the whole article is rated for ‘fakeness’. Knowledge-based approaches fact-check claims made in the article using exogenous data. If an article contains false assertions, then it is likely to be fake news. Two methods of knowledge-based approaches are information retrieval, which is a direct query of information, and semantic web, a graph-based approach. In some cases, fact checking may also involve identifying probability of misinformation by comparing text to an article that does not contain misinformation.

While fact checking can be useful, the described techniques for providing misinformation detection in online content focus on linguistic features, including performing semantic analysis and syntactic analysis. Misinformation falls into a discrete taxonomy. These misinformation categories have certain styles of writing, or linguistic fingerprints. Clickbait frequently manifests as a list of the N most extreme items in a category, for example. Combining these linguistic profiles with some metadata, such as author, publisher, and date of publication, allows for an evaluation of whether an article fits into one of these categories of misinformation.

The described techniques can incorporate aspects of style-based approaches and context-based approaches. Style-based approaches rely on the syntax and diction of the article. There are two branches of research: identifying hallmarks of lying itself and categorizing texts. Identifying a lie has much broader applications, including fake review detection in addition to fake news detection. One pitfall is that fake news may be written with a formal news style, which would be undetected by an algorithm that is based solely on style analysis. The text categorization approach defines a class of articles—such as satire—and identifies linguistic fingerprints of that category. Then, the whole category of articles can be classified as real or fake.

Context-based approaches use information about the article, rather than the article itself, to categorize the article as fake or genuine. A social network analysis is an example of a context-based approach. A social network analysis identifies patterns that fake news exhibits in social media—such as rate and speed of sharing and identifies fake news that way. An evaluation of publishers both through a known database and publisher network is another example of a context-based approach. Other possible context-based approaches may be crowdsourcing (which may weigh votes according to the user's previous voting accuracy) or trend analysis.

As mentioned above, the described techniques incorporate machine and hybrid intelligence implementing both semantic analysis and syntactic analysis. In some cases, for misinformation detection in online content, a URL to content can be received, and in response to receiving the URL, text from content referenced by the URL and metadata associated with the URL can be obtained. The metadata associated with the URL can include, but is not limited to, an author, a publisher, a date of publication, a headline, or a combination thereof. A series of determinations may be carried out before performing machine/hybrid intelligence activities for misinformation detection to minimize use of computational and network resources. For example, a determination can be made of whether the URL is from a distrusted domain. If the URL is from a distrusted domain, a misinformation notification can be provided to a source of the request without performing machine intelligence. If the URL is not from a distrusted domain, a determination of whether the URL is a previously received URL can be made. If the URL is a previously received URL, cached information of the previously received URL can be provided from a data resource (and thus also avoid having to perform the machine intelligence activities). If the URL is not a previously received URL, a determination can be made as to whether the content referenced by the URL is a duplicate content (same or even very similar content, such as changing a single word or phrase). If the content referenced by the URL is the duplicate content, cached information of a URL referencing the duplicate content can be provided from the data resource (and thus also avoid having to perform the machine intelligence activities).

If the content referenced by the URL is not the duplicate content, a misinformation probability analysis of the URL, obtained text, and the metadata associated with the URL can be performed using a feature set at a misinformation probability service. The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and then provided.

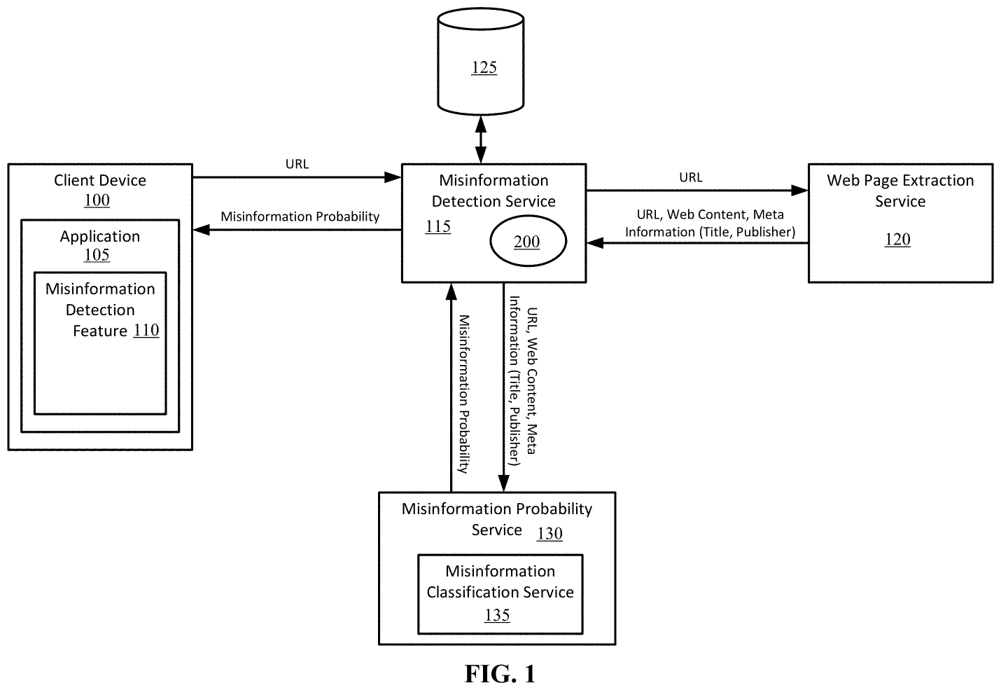

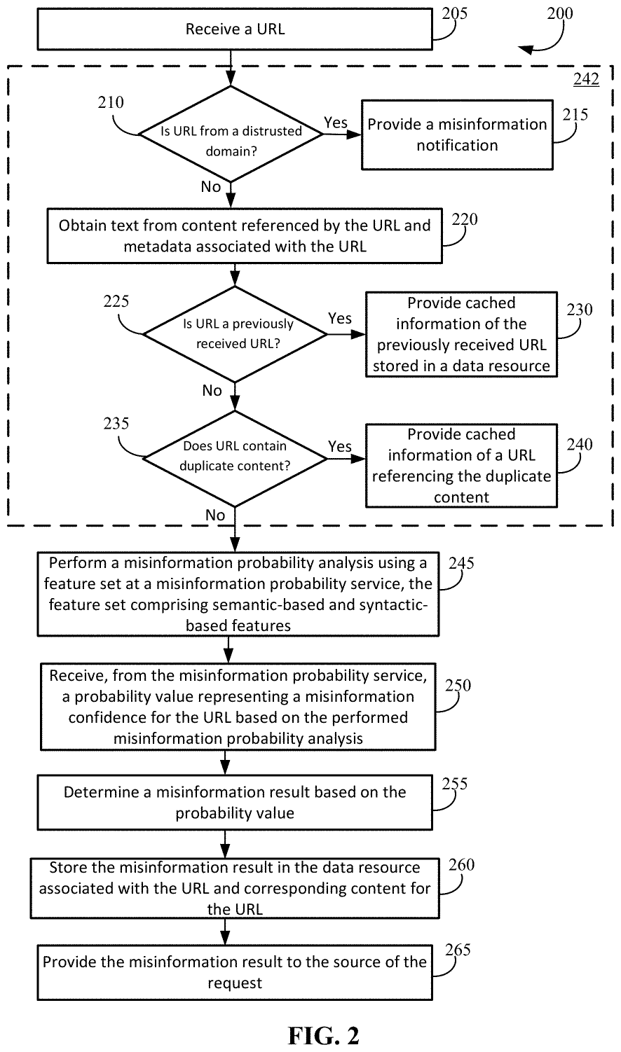

FIG. 1 illustrates an example operating environment in which certain implementations of the techniques described herein for misinformation detection in online content may be practiced; and FIG. 2 illustrates an example process for misinformation detection in online content. Referring to FIG. 1, the example operating environment may include a client device 100, an application 105 with a misinformation detection feature 110, a misinformation detection service 115, a web page extraction service 120, a data resource 125, a misinformation probability service 130, and a misinformation classification service 135.

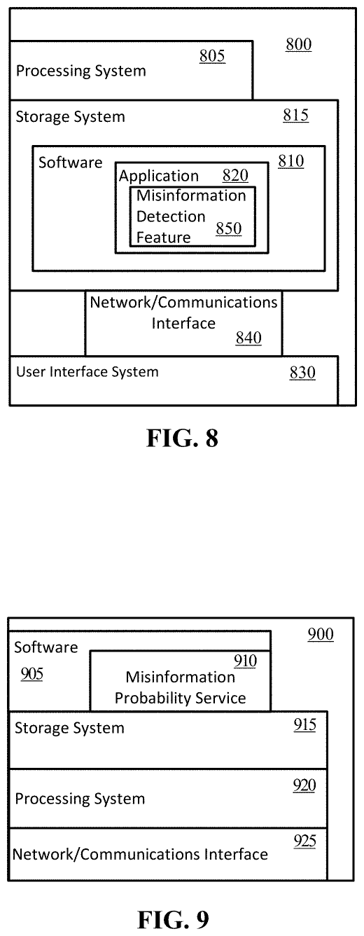

The misinformation detection service 115 can support the misinformation detection feature 110 for the application 105 and can perform process 200 as described with respect to FIG. 2. The misinformation detection service 115 can implement any suitable machine learning/deep learning model applying the described feature sets. Through the misinformation detection service 115, the misinformation detection feature 110 can be added to any website (or other Internet-accessible location with content and executable code) or application. Client device 100, the misinformation detection service 115, and the web page extraction service 120 may each independently or in combination be embodied such as described with respect to system 800 of FIG. 8 or system 900 of FIG. 9. The misinformation probability service 130 and the misinformation classification service 135 may each independently or in combination be embodied as system 800 or 900, or may be incorporated as part of any of the client device 100, the misinformation detection service 115, and the web page extraction service 120.

Client device 100 may be a general-purpose device that has the ability to run one or more applications. The client device 100 may be, but is not limited to, a personal computer, a laptop computer, a desktop computer, a tablet computer, a reader, a mobile device, a personal digital assistant, a smart phone, a gaming device or console, a wearable computer, a wearable computer with an optical head-mounted display, computer watch, or a smart television.

The client device 100 may be used to execute the application 105 and communicate over a network (not shown). Application 105 may be used to browse the Web and run applications, such as a browser, a social media application, or an email application. Examples of browsers include, but are not limited to, MICROSOFT INTERNET EXPLORER, GOOGLE CHROME, APPLE SAFARI, and MOZZILA FIREFOX. Examples social media applications include, but are not limited to, FACEBOOK, LINKEDIN, INSTAGRAM, and TWITTER. Examples of email applications include, but are not limited to, MICROSOFT OUTLOOK, YAHOO! MAIL, and GOOGLE GMAIL.

The misinformation detection feature 110 can be embedded components in a corresponding web page or application. The misinformation detection feature 110 may be, for example, a plug-in, add on, or extension. A browser extension refers to a small program that can be used to add new features to a web browser or modify and enhance the existing functionality of the web browser.

The data resource 125 stores information on URLs and articles, including information such as probabilities, labels, or taxonomic categorization generated by the misinformation detection service. The first time an article is seen by the system, a misinformation probability analysis is performed on the article and the results are stored with the article, along with the URL, corresponding content for the URL, and in some cases, the associated metadata. Using the data resource 125 during pre-processing of the URL helps avoid repeat computation. Pre-processing will be described in more detail in step 242 of process 200 described with respect to FIG. 2. The data resource 125, in combination with performing a duplicate determination (described in more detail with respect to FIG. 2), can also make it harder for publishers to circumvent a publisher level filter by just changing their name or URL. The data resource 125 may be a single resource or multiple resources located in separate locations. In some cases, the data resource 125 can be located at the client device 100. In some cases, the data resource 125 may be at a centralized back end and used for storing specific user based or community-based information regarding misinformation results. In some cases, the data stored in the data resource 125 can be in the form of a hash table, and a variety of optimization techniques on accessing the table may be carried out.

The misinformation probability service 130 can perform a misinformation probability analysis of a URL to provide a probability value representing a misinformation confidence. In some cases, the misinformation probability service 130 can be a machine learning service and include a machine learning model, such as a support vector machine (SVM) or any other machine learning model or deep learning model that can provide probability of a certain outcome. In some cases, the misinformation probability service 130 can be a machine intelligence service or a hybrid intelligence service. In some cases, misinformation probability service 130 can include a deep-learning model.

The machine learning model can be trained on an aggregated dataset of a plurality of articles from a variety of sources, topics, and lengths. The dataset can include the text, title, author, publisher, date of publication, and the URL of each article. In some cases, well-known datasets and freely available sources can be compiled and included in the aggregated dataset.

In some cases, the misinformation probability service 130 also provides classification of the misinformation through a misinformation classification service 135 included with, or in communication with, the misinformation probability service 130. The classification of the misinformation includes determining a misinformation result by assigning a misinformation category to the misinformation. In some cases, the classification of the misinformation is performed by a separate misinformation classification service 135. In cases where the misinformation classification service 135 is separate, the misinformation probability service 130 can provide the probability value, along with additional information from the misinformation probability analysis, to assign the classification of the misinformation.

Components (computing systems, storage resources, and the like) in the operating environment may operate on or in communication with each other over a network (not shown). The network may be an internet, an intranet, or an extranet, and can be any suitable communications network including, but not limited to, a cellular (e.g., wireless phone) network, the Internet, a local area network (LAN), a wide area network (WAN), a WiFi network, or a combination thereof. Such networks may involve connections of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks, as will be understood by those skilled in the art. As will also be appreciated by those skilled in the art, communication networks can take several different forms and can use several different communication protocols.

Communication to and from the components, such as between the misinformation detection feature 110 and the misinformation detection service 115, may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Referring to both FIG. 1 and FIG. 2, the misinformation detection service 115 can receive a URL (205). The URL may be received a variety of ways. The URL may be received in response to a request from a user for misinformation detection for the URL. In some cases, the URL may be automatically received when the URL is received at the application 105. In an example, the URL may be received when a user is at a media aggregator, such as a social media application, a search engine, or any other website that presents the user with multiple articles from varied sources. In another example, the URL may be received when a user encounters the URL to an article in, for example, an email, in another article, or in a comment. In yet another example, the URL may be received when the user is at the website and viewing an article.

The service 115 can analyze the URL or the content at the URL to determine if the URL and/or the content was previously received. If the URL and/or content was previously received, a notification using cached information can be provided; else if the URL and/or content was not previously received, a misinformation probability analysis can be performed. In an illustrative example, in response to receiving the URL (205), the misinformation detection service 115 can determine whether the URL is from a distrusted domain (210). The determination of whether the URL is from a distrusted domain can include querying a whitelist of domains, querying a blacklist of domains, or querying both the whitelist of domains and the blacklist of domains for a domain of the URL. For example, if the domain is found in the whitelist of domains (e.g., a list of domains viewed with approval) the domain of the URL may be determined to be trusted. If the domain is found in the blacklist of domains (e.g., a list of people or products viewed with suspicion or disapproval) the domain of the URL may be determined to be distrusted. If the domain is not found in either the whitelist or the blacklist, the trust of domain of the URL may be unknown.

In some cases, a determination can be made whether other information, such as the author of the content referenced by the URL, is found in a whitelist or a blacklist.

If the URL is determined to be from a distrusted domain, a misinformation notification can be provided (215). The misinformation notification provided may be similar to a misinformation result (e.g., given a value or confidence level or a label).

If the URL is determined to not be from a distrusted domain (e.g., a trusted domain or an unknown domain), the URL can be further processed. In some cases, if the URL is determined to be from a trusted domain, a notification may be provided. The notification may indicate there is a low probability of misinformation. In some cases where the URL is determined to be from a trusted domain, no additional analysis is conducted for that URL; instead the system may provide a “no misinformation” or “low probability of misinformation” notification.

The misinformation detection service 115 can obtain text from content referenced by the URL, as well as metadata associated with the URL (220). The text and metadata may be obtained from the web page extraction service 120. The metadata associated with the URL can include, for example, an author, a publisher, a date of publication, and a headline of the content referenced by the URL. It should be understood that, in alternative implementations, the extraction may be performed prior to or contemporaneously with the determination operation 210.

The misinformation detection service 115 can determine whether the URL is a previously received URL (225). Because the same article may be encountered by many different users, the determination of whether the URL is a previously received URL can include querying the data resource 125 for the URL. As previously described, the information (e.g., misinformation results) from previously received articles are stored with the URL. Thus, if the URL has been previously seen, the data resource 125 will contain the cached information (e.g., misinformation results) and further processing is not needed.

If the URL is a previously received URL, the cached information of the previously received URL may be provided (230) from the data resource 125. The cached information may include the misinformation results.

If the URL is not a previously received URL, the URL can be further processed. The misinformation detection service 115 can determine whether the URL contains duplicate content (235). Duplicate content may include similar content (e.g., content with a single word or phrase changed) from an article that has already been processed by the system. The determining of whether the URL contains duplicate content can include performing a fuzzy hash on the obtained text from the content referenced by the URL. Using a fuzzy hash can prevent having to re-evaluate an article when a publisher makes minor changes to the article and publishing or repackaging the article as new. For example, one corporation may own five or six websites and may post the same articles (each having a different URL). In another example, a user may copy content another user posted to their blog and paste that content into their own blog. In order to prevent wasting essential computing resources on providing a misinformation probability analysis on each duplicate article, each URL is checked for a duplicate article already analyzed. Even if a user posts an article with some words changed, the system can recognize that the same or similar article content is being referenced and will provide the same results. The extent of similarities may be based on different granularities, for example, at a page level or at a whole article level. As mentioned above, the determination can be based on fuzzy hashing and a selected or predetermined threshold for percentage similarity.

If the URL contains duplicate content, cached information of the URL referencing the duplicate content is provided (240) from the data resource 125. The cached information can include the misinformation results.

Together, steps 210, 215, 220, 225, 230, 235, and 240 can be considered pre-processing (242) of the URL for the misinformation probability analysis. An article need only be run through the misinformation probability analysis the first time it is seen by the system. The pre-processing (242) can filter out many of the many duplicate articles found online that have already been run through the misinformation probability analysis. The system can then provide the results of the previous analysis instead of sending the URL to the misinformation probability service to be analyzed. Advantageously, this pre-processing of the URL before the misinformation probability analysis can improve bandwidth and performance and can reduce processing power required.

If the URL does not contain duplicate content, a misinformation probability analysis is performed on the URL (245). The misinformation probability analysis can be performed using a feature set at the misinformation probability service 135. The feature set used for the misinformation probability analysis includes both semantic-based features and syntactic-based features.

The misinformation probability service 130 applies a featurization to the URL, obtained text, and associated metadata and runs it through the machine learning model to produce a probability value representing the misinformation confidence. In some cases, the obtained text is scrubbed of certain information, such as quotes, before the featurization.

The semantic-based features and the syntactic-based features can include sentiment amplifiers, sentiment continuity disruption features, lexical features, keywords, baseline features, sensicon features, speech act, emotion detection on the obtained text, exaggerated language, strong adjectives, heuristics, bag-of-words, objectivity, colloquial-ness score, and semantic difference. The feature set can also include one or more of external link counts, user trust scores, and user voting.

The sentiment amplifiers feature can include a sentiment analysis of the sentiment on a sentence level and an article level. The sentiment analysis can show if the article contains a large range of sentiments, or if the sentiment is more towards neutral. In most cases, the sentiment level of factual articles is close to neutral.

The sentiment continuity disruption features can include an analysis of any polarity changes. Both the sentence polarity and the paragraph polarity may be analyzed. Analyzing polarity change can include, for example, determining if the article started with a strongly positive sentence and ended with a really strong negative connotation. In most cases, sentiment levels of polarity, in a news context, are going to be almost zero because facts are being stated as opposed to expressing extreme emotions that start with, for example, “the worst”, “loser”, “huge”, or “great”.

In some cases, polarity may be identified by identifying sentence sentiment between clauses. For example, if the first part of a clause has a really positive polarity and the last part of the clause is extremely negative, the polarity change can be computed. The polarity change may also be computed at a sentence level, at a paragraph level, and at a page level.

In some cases, the sentiment analysis may go beyond just basic sentiment analysis, such as positive, negative, and neutral, to a deeper sentiment analysis. The sentiment analysis can include emotion detection on the obtained text includes a pretrained classifier providing probabilities for each of Ekman's six emotions plus the neutral emotion. Ekman's six emotions include anger, happiness, surprise, disgust, sadness, and fear.

The lexical features can look at, for example, numbers, capital letters, and punctuation used in an article, such as the amount of punctuations and the types of punctuations used. For example, in most cases, a news article will not contain a large amount of exclamation points. A word or character count feature may be included in the feature set.

The keywords feature can include words identified as occurring frequently in articles containing misinformation (as determined on a training set and/or added by human).

The baseline features include n-gram baseline features. For the baseline features, the machine learning model can be trained on, for example, certain uni-grams (which may be considered keywords), bi-grams, tri-grams, skip-grams, or combinations thereof. For example, certain bi-grams (e.g. a set of two words like “baby bump” or “foundation cash”) may be found to occur very frequently in articles containing misinformation (as determined on the training set). The n-grams can be extracted from the obtained text and associated metadata and a determination can be made as to whether the article contains an n-gram that was found during any previous training.

In some cases, the obtained text and associated metadata may be transformed into a bag-of-words model to allow multiple features to be generated, such as the keywords and the baseline features.

The exaggerated language feature can include profanity and slang. The presence of exaggerated language in an article would indicate that the article is a non-professional write-up.

The strong adjectives feature can also indicate misinformation. A strong adjective is more expressive than normal adjectives and can be used with adverbs like really or absolutely. Other parts of speech are also identified, such as adverbs, verbs, and adjectives. A high number of modifiers may indicate misinformation.

The sensicon features can determine sense scores for sight, hearing, smell, and touch. The sensicon features can identify if there are a lot of sensing words present in the test. For example, the sensicon features can identify if the author is describing what they are seeing or what they are hearing.

The semantic difference feature can determine the semantic difference between the headline and content of the article using word embeddings and cosine similarities. The word embeddings can include n-dimensional word embeddings and can be used to identify the distance between words that come together in a particular article. The semantic difference can also be done at the character level (e.g., character level embedding).

The semantic difference feature can be used to perform a clickbait check. The distance between the headline and the content can be determined; and the greater the distance, the greater the chance the article is clickbait.

The speech act feature can decide whether a statement is an opinion or non-opinion piece based on the kind of words that used in the article.

The objectivity feature can determine if an assertion is fact or emotion based.

The heuristics feature incorporates knowledge from domain experts on fake-news style. It used to create flags and features generated from human expertise.

The bag-of-words feature records which 2-or-more words are frequently used in tandem in misinformation articles.

The colloquial-ness feature measures the informalness of the language used, including grammar, slang, and obscene vocabulary.

The feature set may further include external link counts, user trust scores, and user voting. For example, a user may consider the misinformation result provided, but think it's wrong (or correct). The user can vote on the misinformation result. For the user trust scores, each user has a trust score. The trust score can be based on, for example, their history of voting and whether or not it conflicts with misinformation results that have a high confidence level.

Returning to FIG. 1 and FIG. 2, the misinformation detection service 115 can receive, from the misinformation probability service 130, a probability value representing a misinformation confidence for the URL based on the performed misinformation probability analysis (250). The probability value is a probabilistic number that identifies a percent of confidence or a probability that the article may contain misinformation. Instead of labeling an entire article as either misinformation or not misinformation, the probability that an article contains misinformation is provided.

A misinformation result can be determined based on the probability value (255). In some cases, determining the misinformation result can include assigning a misinformation confidence level to the content referenced by the URL based on the probability value. The misinformation confidence level can be, for example, a high confidence level, a medium confidence level, or a low confidence level.

The probability value can range from 0 to 1, with 0 being the lowest confidence and 1 being the highest confidence. For example, the misinformation result for a probability value between 0 and 0.25 can be a high confidence that the article does not contain misinformation. In another example, the misinformation result for a probability value between 0.26 and 0.50 can be a low confidence that the article contains misinformation. In another example, the misinformation result for a probability value between 0.51 and 0.75 can be a medium confidence that the article contains misinformation (and thus a medium confidence the article contains no misinformation). In yet another example, the misinformation result for a probability value between 0.76 and 1 can be a high confidence that the article contains misinformation (and thus a low confidence the article contains no misinformation). The threshold can be optimally chosen based on, for example, the precision-recall or AUC curves—such as the threshold with the maximum F1 score. Alternatively, the thresholds may be chosen based on business considerations or beliefs around false positives and error tolerance Of course, other ranges may be used.

In some cases, determining the misinformation result based on the probability value can include assigning a misinformation category to the content referenced by the URL based on at least the probability value. As previously described, examples of misinformation categories include, but are not limited to, satire, extreme bias, conspiracy theory, rumor mill, state-sponsored news, junk science, hate news, clickbait, politically motivated, and hyperpartisan. These misinformation categories can have certain styles of writing, or linguistic fingerprints. For example, clickbait frequently manifests as a list of the N most extreme items in a category. Combining these linguistic profiles (e.g., results of the featurization) with the associated metadata, such as author, publisher, and date of publication, allows for an evaluation of if an article fits into one of these categories of misinformation.

In some cases, each misinformation category will include a machine learning model and the article will run through each of model for possible matches. If the article does not meet the criteria for any of the models, the article will move on to the next stage of the misinformation determination. If it matches on or more subcategories, that information will be provided.

In one example, as previously described, the semantic difference feature can be used to perform a clickbait check. In this example, the distance between the headline and the content can be determined; and the greater the distance, the greater the chance the article is clickbait.

In some cases, the misinformation detection service 115 can determine the misinformation result. For example, once the misinformation detection service 115 receives the probability value, the misinformation detection service 115 can assign the confidence level based on the received probability value.

In some cases, the misinformation classification service 135 can determine the misinformation result. For example, the misinformation classification service 135 can assign the misinformation category based on at least the probability value.

In some cases, the misinformation probability service 130 can determine the misinformation result. For example, the misinformation probability service 130 can assign the misinformation category at the same time the probability value is determined.

In cases where the misinformation probability service 130 does not determine the misinformation result, additional information (other than just the probability value) may be obtained. The additional information can be obtained from the misinformation probability service 130.

The misinformation detection service 115 can store the determined misinformation result (260) in the data resource 125 associated with the URL and the corresponding content for the URL. The stored misinformation result can be used for future pre-processing steps. The misinformation detection service 115 can provide the misinformation result (265). The misinformation results can be displayed to the user in a variety of ways.

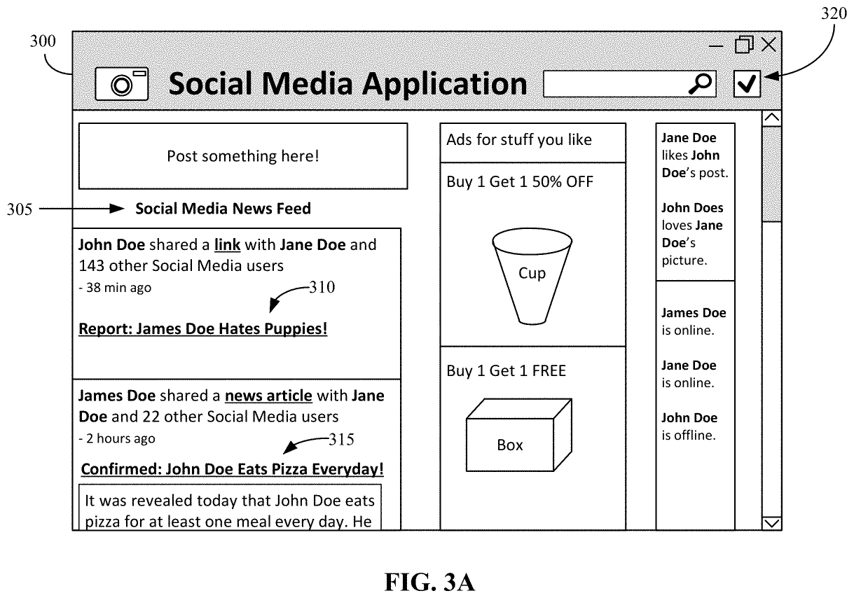

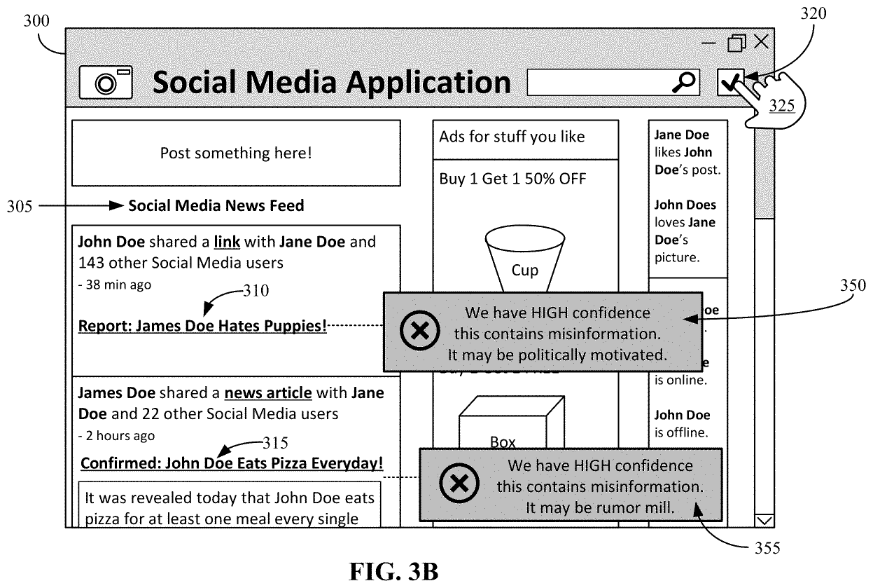

FIGS. 3A and 3B illustrate an example scenario of performing misinformation detection in a social media application. Referring to FIG. 3A, a social media application 300 can include a misinformation detection feature to provide misinformation detection for content of the social media application 300.

In the example illustrated in FIG. 3A, a social media news feed 305 for a user, Jane Doe, is provided in the social media application 300. The social media news feed 305 shows that a friend, John Doe, shared a link (e.g., link 310) with Jane Doe and another friend, James Doe, shared a news article (e.g., news article 315) with Jane Doe. Each item (e.g., the link 310 and the news article 315) is shown as a separate object in the social media news feed 305. Link 310 is a link to an article with the title “Report: James Doe Hates Puppies!” and news article 315 is a link to an article with the title “Confirmed: John Doe Eats Pizza Everyday!”.

Instead of selecting the link 310 or the news article 315 and going straight to the corresponding website, the user can request that misinformation detection be performed on one or more of the items. The user can request the misinformation detection a variety of ways, such as hovering over the link or selecting a command (e.g., a misinformation detection command 320). In some cases, selecting the misinformation detection command 320 can automatically provide misinformation results for each item. In other cases, selecting the misinformation detection command 320 allows the user to hover over a link to obtain the misinformation result. In some cases, the misinformation detection can be automatically performed (and such a feature be set in the settings of the application).

The misinformation detection can be provided in the social media application 300 to help the user better understand the content they are consuming. As previously described, misinformation results of the misinformation detection do not block the article and are not a censorship of the articles. Further, the misinformation results are not a judgement of whether the item should or shouldn't be consumed. The misinformation results can provide an amount of criticality to consider when consuming the article, instead of accepting the article without thought.

Referring to FIG. 3B, the user selects (325) the misinformation detection command 320. In response to the user's selecting (325) the misinformation detection command 320, misinformation detection is performed for a URL for each item (e.g., link 310 and news article 315) and misinformation results (e.g., misinformation result 350 and misinformation result 355) are provided.

The misinformation detection performed for the link 310 can include, as previously described, a pre-processing of the URL to determine if a misinformation probability analysis needs to be performed. If the misinformation probability analysis needs to be performed, the misinformation probability analysis of the URL, obtained text, and the metadata associated with the URL can be performed using a feature set at a misinformation probability service. The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and the misinformation result can be provided.

In the example of link 310, the misinformation result 350 indicates that there is a high confidence level that the content in the article for the link 310 contains misinformation. Further, the misinformation result 350 indicates the category of the misinformation contained in the article. In this case, the category may be “politically motivated.”

A similar misinformation detection can be performed for the news article 315. In the example of news article 315, the misinformation result 355 indicates that there is a high confidence level that the content for the news article 315 contains misinformation. Further, the misinformation result 355 indicates the category of the misinformation contained in the article. In this case, the category may be “rumor mill.”

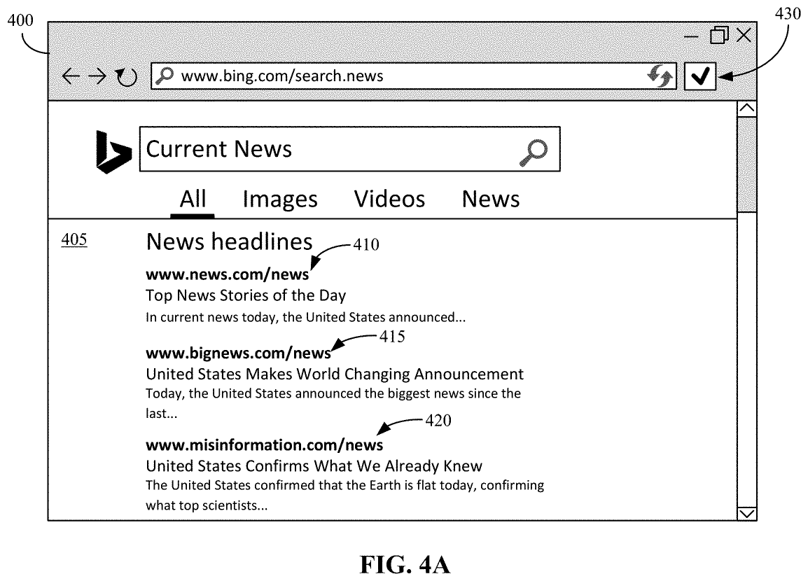

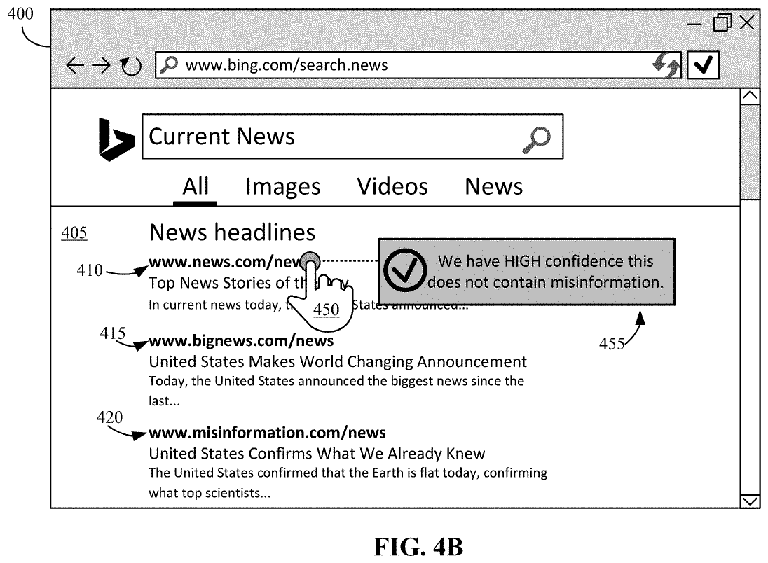

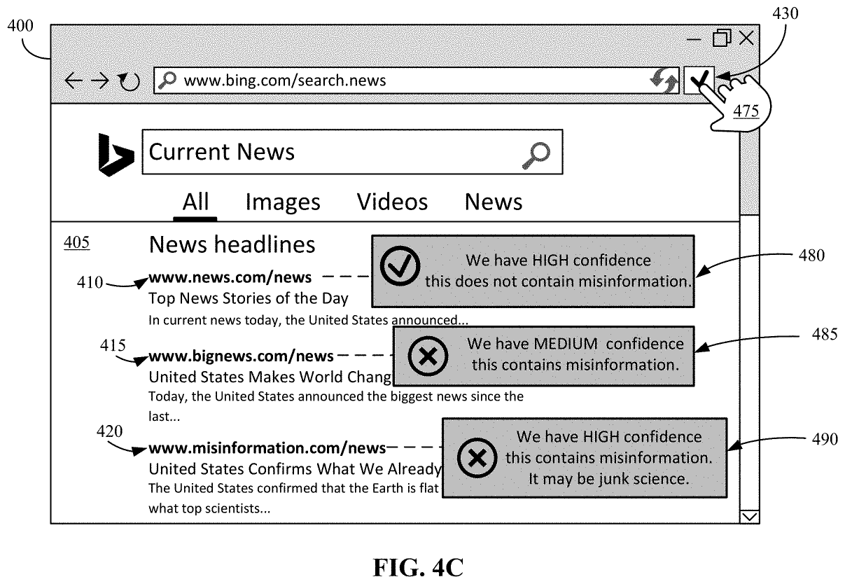

FIGS. 4A-4C illustrate example scenarios of performing misinformation detection at a search engine. Referring to FIG. 4A, a web browser 400 can include a misinformation detection feature to provide misinformation detection for results presented in a search engine results page 405 displayed by a search engine running in the web browser 400.

In the example illustrated in FIG. 4A, the search engine results page 405 shows three search results (e.g., search result 410, search result 415, and search result 420) of a search for the term “Current News.” As can be seen, the search result 410 includes a link for “news/news;” the search result 415 includes a link for “bignews/news;” and the search result 420 includes a link for “misinformation/news.”

Instead of selecting one of the search results and going straight to the corresponding website, the user can request that misinformation detection be performed on one or more of the search results. As previously described, the user can request the misinformation detection a variety of ways, such as hovering over the link or selecting a command (e.g., a misinformation detection command 430).

The misinformation detection can be provided in the web browser 400 to help the user better understand the content they are consuming. As previously described, misinformation results of the misinformation detection do not block the article and are not a censorship of the articles. Further, the misinformation results are not a judgement of whether the item should or shouldn't be consumed. The misinformation results can provide an amount of criticality to consider when consuming the article, instead of accepting the article without thought.

Referring to FIG. 4B, the user hovers over (450) the search result 410. In response to detecting that the user is hovering over the search result 410, misinformation detection can be performed for a URL for the selected search result 410 and a misinformation result 480 is provided.

The misinformation detection performed for the search result 410 can include, as previously described, a pre-processing of the URL to determine if a misinformation probability analysis needs to be performed. If the misinformation probability analysis needs to be performed, the misinformation probability analysis of the URL, obtained text, and the metadata associated with the URL can be performed using a feature set at a misinformation probability service. The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and the misinformation result can be provided.

In the example of search result 410, the misinformation result 455 indicates that there is a high confidence level that the content in the article of the search result 410 does not contain misinformation.

Referring to FIG. 4C, the user selects (475) the misinformation detection command 430. In response to the user selecting the misinformation detection command 430, misinformation detection is performed for a URL for each search result (e.g., search result 410, search result 415, and search result 420) and misinformation results (e.g., misinformation result 480, misinformation result 485, and misinformation result 490) are provided.

The misinformation detection performed for the search result 410 can include, as previously described, a pre-processing of the URL to determine if a misinformation probability analysis needs to be performed. If the misinformation probability analysis needs to be performed, the misinformation probability analysis of the URL, obtained text, and the metadata associated with the URL can be performed using a feature set at a misinformation probability service. The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and the misinformation result can be provided.

In the example of search result 410, the misinformation result 480 indicates that there is a high confidence level that the content in the article of the search result 410 does not contain misinformation.

A similar misinformation detection can be performed for the search result 415 and search result 420. In the example of search result 415, the misinformation result 485 indicates that there is a medium confidence level that the content for the search result 415 contains misinformation. In the example of search result 420, the misinformation result 490 indicates that there is a high confidence level that the content for the search result 420 contains misinformation. Further, the misinformation result 490 indicates the category of the misinformation contained in the article. In this case, the category may be “junk science.”

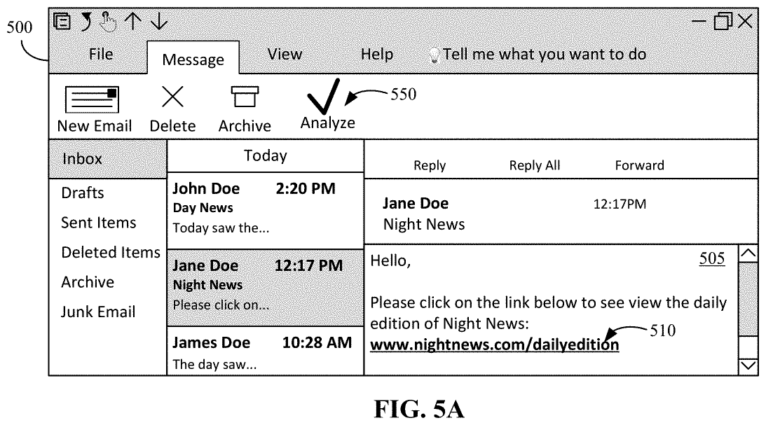

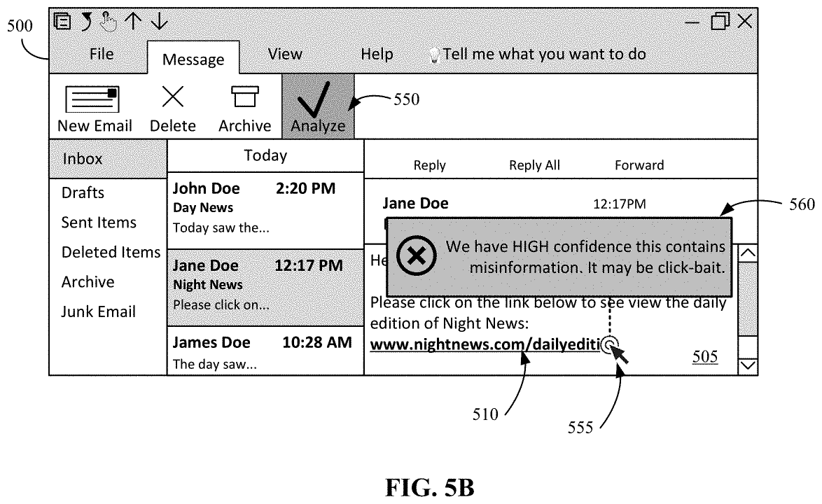

FIGS. 5A and 5B illustrate an example scenario of performing misinformation detection in an email application. Referring to FIG. 5A, an email application 500 can include a misinformation detection feature to provide misinformation detection for emails in the email application 500.

In the example illustrated in FIG. 5A, the email application 500 shows an example email message 505 from Jane Doe. As can be seen, the email message 505 includes a link 510 for “nightnews/daily edition.”

Instead of selecting the link 510 and being brought straight to the corresponding website, the user can request that misinformation detection be performed on the link 510 As previously described, the user can request the misinformation detection a variety of ways, such as hovering over the link or selecting a command (e.g., a misinformation detection command 550). In some cases, selecting the misinformation detection command 550 can automatically provide misinformation results for each item. In other cases, selecting the misinformation detection command 550 allows the user to hover over a link to obtain the misinformation result.

The misinformation detection can be provided in the email application 500 to help the user better understand the content they are consuming. As previously described, misinformation results of the misinformation detection do not block the article and are not a censorship of the articles. Further, the misinformation results are not a judgement of whether the item should or shouldn't be consumed. The misinformation results can provide an amount of criticality to consider when consuming the article, instead of accepting the article without thought.

Referring to FIG. 5B, the user first selects the misinformation detection command 550 and then hovers over (550) the link 510. In response to detecting that the user is hovering over the link 510, misinformation detection can be performed for a URL for the selected link 510 and a misinformation result 560 is provided.

The misinformation detection performed for the link 510 can include, as previously described, a pre-processing of the URL to determine if a misinformation probability analysis needs to be performed. If the misinformation probability analysis needs to be performed, the misinformation probability analysis of the URL, obtained text, and the metadata associated with the URL can be performed using a feature set at a misinformation probability service. The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and the misinformation result can be provided.

In the example of link 510, the misinformation result 560 indicates that there is a high confidence level that the content in the article of the link 560 contains misinformation. Further, the misinformation result 560 indicates the category of the misinformation contained in the article. In this case, the category may be “click-bait.”

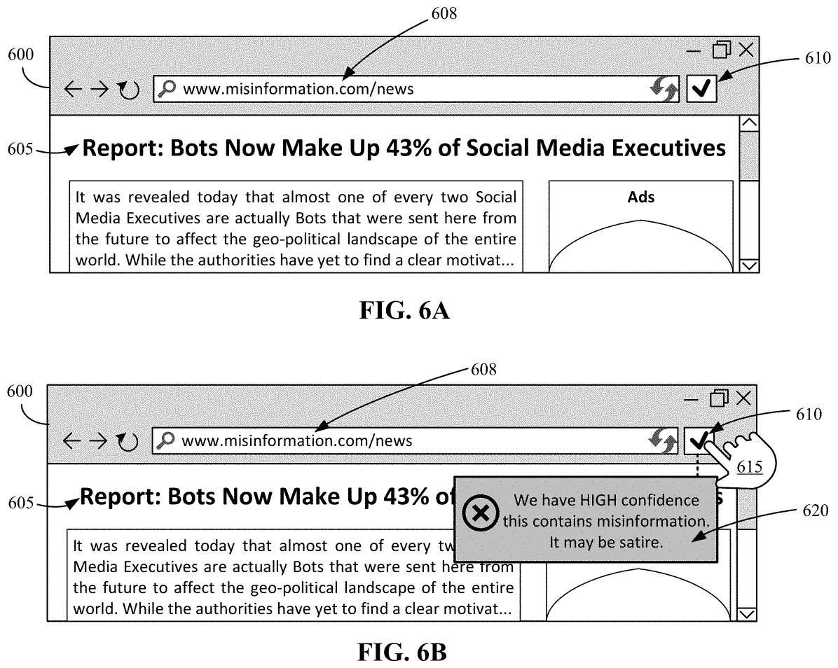

FIGS. 6A and 6B illustrate an example scenario of performing misinformation detection at an article website. Referring to FIG. 6A, a web browser 600 can include a misinformation detection feature to provide misinformation detection for websites accessed in the web browser 600.

In the example illustrated in FIG. 6A, the web browser 600 shows an example article 605 having a title “Report: Bots Now Make Up 43% of Social Media Executives” and a URL 608 of “www.misinformation.com/news.”

As the user is consuming the article 605, the user can request that misinformation detection be performed on the URL 608. As previously described, the user can request the misinformation detection a variety of ways, such as hovering over the link or selecting a command (e.g., a misinformation detection command 610). In some cases, selecting the misinformation detection command 610 can automatically provide misinformation results for each item. In other cases, selecting the misinformation detection command 610 allows the user to hover over a link to obtain the misinformation result.

The misinformation detection can be provided in the web browser 600 to help the user better understand the content they are consuming. As previously described, misinformation results of the misinformation detection do not block the article and are not a censorship of the articles. Further, the misinformation results are not a judgement of whether the item should or shouldn't be consumed. The misinformation results can provide an amount of criticality to consider when consuming the article, instead of accepting the article without thought.

Referring to FIG. 6B, the user selects (615) the misinformation detection command 610. In response to selecting (615) the misinformation detection command 610, misinformation detection can be performed for the URL 608 and a misinformation result 620 can be provided.

The misinformation detection performed for the URL 608 can include, as previously described, a pre-processing of the URL to determine if a misinformation probability analysis needs to be performed. If the misinformation probability analysis needs to be performed, the misinformation probability analysis of the URL, obtained text, and the metadata associated with the URL can be performed using a feature set at a misinformation probability service. The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and the misinformation result can be provided.

In the example of URL 608, the misinformation result 620 indicates that there is a high confidence level that the content in the article 605 contains misinformation. Further, the misinformation result 620 indicates the category of the misinformation contained in the article 605. In this case, the category may be “satire.”

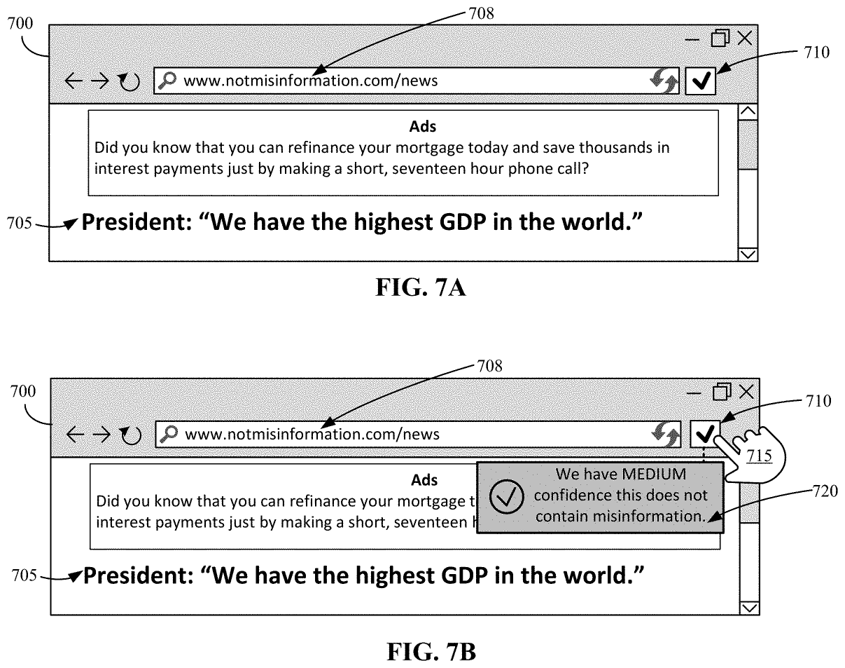

FIGS. 7A and 7B illustrate an example scenario of performing misinformation detection at an article website. Referring to FIG. 7A, a web browser 700 can include a misinformation detection feature to provide misinformation detection for websites accessed in the web browser 700.

In the example illustrated in FIG. 7A, the web browser 700 shows an example article 705 having a title “President: ‘We have the highest GDP in the world.’” and a URL 708 of “www.notmisinformation.com/news.”

As the user is consuming the article 705, the user can request that misinformation detection be performed on the URL 708. As previously described, the user can request the misinformation detection a variety of ways, such as hovering over the link or selecting a command (e.g., a misinformation detection command 710). In some cases, selecting the misinformation detection command 710 can automatically provide misinformation results for each item. In other cases, selecting the misinformation detection command 710 allows the user to hover over a link to obtain the misinformation result.

The misinformation detection can be provided in the web browser 700 to help the user better understand the content they are consuming. As previously described, misinformation results of the misinformation detection do not block the article and are not a censorship of the articles. Further, the misinformation results are not a judgement of whether the item should or shouldn't be consumed. The misinformation results can provide an amount of criticality to consider when consuming the article, instead of accepting the article without thought.

Referring to FIG. 7B, the user selects (715) the misinformation detection command 710. In response to selecting (715) the misinformation detection command 710, misinformation detection can be performed for the URL 708 and a misinformation result 720 can be provided.

The misinformation detection performed for the URL 708 can include, as previously described, a pre-processing of the URL to determine if a misinformation probability analysis needs to be performed. If the misinformation probability analysis needs to be performed, the misinformation probability analysis of the URL, obtained text, and the metadata associated with the URL can be performed using a feature set at a misinformation probability service. The feature set includes both semantic-based features and syntactic-based features. A probability value representing a misinformation confidence for the URL based on the performed misinformation probability analysis can be received from the misinformation probability service. A misinformation result can be determined based on the probability value. The misinformation result can be stored in the data resource associated with the URL and corresponding content for the URL and the misinformation result can be provided.

In the example of URL 708, the misinformation result 720 indicates that there is a medium confidence level that the content in the article 705 does not contain misinformation.

FIG. 8 illustrates components of a computing device that may be used in certain implementations described herein. Referring to FIG. 8, system 800 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to system 800 may be incorporated to implement a particular computing device.

System 800 includes a processing system 805 of one or more processors to transform or manipulate data according to the instructions of software 810 stored on a storage system 815. Examples of processors of the processing system 805 include general purpose central processing units, application specific processors, and logic devices, as well as any other type of processing device, combinations, or variations thereof. The processing system 805 may be, or is included in, a system-on-chip (SoC) along with one or more other components such as network connectivity components, sensors, video display components.

The software 810 can include an operating system and application programs such as application 820 with a misinformation detection feature 850 that may include components for communicating with misinformation detection service and misinformation probability service (e.g. running on server such as system 900). Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 8, can be thought of as additional, nested groupings within the operating system space, each containing an OS, application programs, and APIs.

Storage system 815 may comprise any computer readable storage media readable by the processing system 805 and capable of storing software 810 including the application 820 and the misinformation detection feature 850.

Storage system 815 may include volatile and nonvolatile memory, removable and non-removable media implemented in any method or technology for storage of information, such as computer readable instructions, data structures, program modules, or other data. Examples of storage media of storage system 815 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal or carrier wave.

Storage system 815 may be implemented as a single storage device but may also be implemented across multiple storage devices or sub-systems co-located or distributed relative to each other. Storage system 815 may include additional elements, such as a controller, capable of communicating with processing system 805.

Software 810 may be implemented in program instructions and among other functions may, when executed by system 800 in general or processing system 805 in particular, direct system 800 or the one or more processors of processing system 805 to operate as described herein.

The system can further include user interface system 830, which may include input/output (I/O) devices and components that enable communication between a user and the system 800. User interface system 830 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 830 may also include output devices such as display screen(s), speakers, haptic devices for tactile feedback, and other types of output devices. In certain cases, the input and output devices may be combined in a single device, such as a touchscreen display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display in myriad ways, presenting graphical user interface elements, text, images, video, notifications, virtual buttons, virtual keyboards, or any other type of information capable of being depicted in visual form.

The user interface system 830 may also include user interface software and associated software (e.g., for graphics chips and input devices) executed by the OS in support of the various user input and output devices. The associated software assists the OS in communicating user interface hardware events to application programs using defined mechanisms. The user interface system 830 including user interface software may support a graphical user interface, a natural user interface, or any other type of user interface. For example, the interfaces for the misinformation detection described herein may be presented through user interface system 830.

Communications interface 840 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Computing system 800 is generally intended to represent a computing system with which software is deployed and executed in order to implement an application, component, or service for misinformation detection as described herein. In some cases, aspects of computing system 800 may also represent a computing system on which software may be staged and from where software may be distributed, transported, downloaded, or otherwise provided to yet another computing system for deployment and execution, or yet additional distribution.

FIG. 9 illustrates components of a computing system that may be used to implement certain methods and services described herein. Referring to FIG. 9, system 900 may be implemented within a single computing device or distributed across multiple computing devices or sub-systems that cooperate in executing program instructions. The system 900 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 900 can include a processing system 920, which may include one or more processors and/or other circuitry that retrieves and executes software 905 from storage system 915. Processing system 920 may be implemented within a single processing device but may also be distributed across multiple processing devices or sub-systems that cooperate in executing program instructions.

Examples of processing system 920 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general-purpose CPU.

Storage system(s) 915 can include any computer readable storage media readable by processing system 920 and capable of storing software 905 including instructions for misinformation probability service 910. Storage system 915 may include volatile and nonvolatile memory, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium of storage system a transitory propagated signal or carrier wave.

Storage system 915 may be implemented as a single storage device but may also be implemented across multiple storage devices or sub-systems co-located or distributed relative to each other. Storage system 915 may include additional elements, such as a controller, capable of communicating with processing system 920.

In some cases, storage system 915 includes data resource 930. In other cases, the data resource 930 is part of a separate system with which system 900 communicates, such as a remote storage provider. Such remote storage providers might include, for example, a server computer in a distributed computing network, such as the Internet. They may also include “cloud storage providers” whose data and functionality are accessible to applications through OS functions or APIs. Data resource 930 may include training data. In some cases, Data resource 930 may include data described as being stored as part of data resource 125 of FIG. 1.

Software 905 may be implemented in program instructions and among other functions may, when executed by system 900 in general or processing system 920 in particular, direct the system 900 or processing system 920 to operate as described herein for a service 910 receiving communications associated with an application with a misinformation detection feature and a misinformation detection service such as described herein.

Software 905 may also include additional processes, programs, or components, such as operating system software or other application software. It should be noted that the operating system may be implemented both natively on the computing device and on software virtualization layers running atop the native device operating system (OS). Virtualized OS layers, while not depicted in FIG. 9, can be thought of as additional, nested groupings within the operating system space, each containing an OS, application programs, and APIs.

Software 905 may also include firmware or some other form of machine-readable processing instructions executable by processing system 920.

System 900 may represent any computing system on which software 905 may be staged and from where software 905 may be distributed, transported, downloaded, or otherwise provided to yet another computing system for deployment and execution, or yet additional distribution.

In embodiments where the system 900 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 925 may be included, providing communication connections and devices that allow for communication between system 900 and other computing systems (not shown) over a communication network or collection of networks (not shown) or the air.

Certain techniques set forth herein with respect to misinformation detection may be described in the general context of computer-executable instructions, such as program modules, executed by one or more computing devices including holographic enabled devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

By way of example, and not limitation, computer-readable storage media may include volatile and non-volatile memory, removable and non-removable media implemented in any method or technology for storage of information such as computer-readable instructions, data structures, program modules or other data. Examples of computer-readable storage media include volatile memory such as random access memories (RAM, DRAM, SRAM); non-volatile memory such as flash memory, various read-only-memories (ROM, PROM, EPROM, EEPROM), phase change memory, magnetic and ferromagnetic/ferroelectric memories (MRAM, FeRAM), and magnetic and optical storage devices (hard drives, magnetic tape, CDs, DVDs). As used herein, in no case does the term “storage media” consist of transitory propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving a uniform resource locator (URL);
in response to receiving the URL:
obtaining text from content referenced by the URL and metadata associated with the URL, wherein the metadata associated with the URL comprises an author, a publisher, a date of publication, a headline, or a combination thereof;
analyzing the URL, the obtained text, the metadata associated with the URL, or a combination thereof to determine if previously received;
if previously received, providing a notification from cached information; if not previously received, performing a misinformation probability analysis of the URL, the obtained text, and the metadata associated with the URL using a feature set at a misinformation probability service, the feature set comprising semantic-based features and syntactic-based features;
receiving, from the misinformation probability service, a probability value representing a misinformation confidence for the URL based on the performed misinformation probability analysis;
determining a misinformation result based on the probability value;
storing the misinformation result in the data resource associated with the URL and corresponding content for the URL; and
providing the misinformation result.

2. The method of claim 1, wherein the receiving of the URL is in response to sharing the URL in social media, sharing the URL in an email message, providing search results, or receiving a request for misinformation detection, the request comprising the URL.

3. The method of claim 1, wherein analyzing the URL, the obtained text, the metadata associated with the URL, or a combination thereof to determine if previously received comprises:
determining whether the URL is from a distrusted domain;
if the URL is from a distrusted domain, providing a misinformation notification;
if the URL is not from a distrusted domain, determining whether the URL is a previously received URL;
if the URL is a previously received URL, providing cached information of the previously received URL from a data resource;
if the URL is not a previously received URL, determining whether the content referenced by the URL is a duplicate content; and
if the content referenced by the URL is the duplicate content, providing cached information of a URL referencing the duplicate content from the data resource.

4. The method of claim 3, wherein the determining of whether the URL is from a distrusted domain comprises querying a whitelist of domains, a blacklist of domains, or a combination thereof for a domain of the URL.

5. The method of claim 3, wherein the determining of whether the URL is a previously received URL comprises querying the data resource for the URL, wherein the data resource comprises a hash table.

6. The method of claim 3, wherein the determining of whether the content referenced by the URL is the duplicate content, comprises performing a fuzzy hash on the obtained text from the content referenced by the URL.

7. The method of claim 1, wherein the semantic-based features and the syntactic-based features are selected from a group consisting of: sentiment amplifiers, sentiment continuity disruption features, lexical features, keywords, baseline features, sensicon features, speech act, emotion detection on the obtained text, exaggerated language, strong adjectives, heuristics, bag-of-words, objectivity, colloquial-ness score, and semantic difference,
wherein the misinformation probability service comprises a machine learning service or a hybrid intelligence service.

8. The method of claim 7, wherein the feature set further comprises external link counts, user trust scores, user voting, or a combination thereof.

9. The method of claim 1, wherein determining the misinformation result based on the probability value comprises assigning a misinformation confidence level to the content referenced by the URL based on the probability value, wherein the misinformation confidence level is a high confidence level, a medium confidence level, or a low confidence level.

10. The method of claim 1, wherein determining the misinformation result based on the probability value comprises assigning a misinformation category to the content referenced by the URL based on at least the probability value.

11. A system comprising:
a processing system;
a storage system; and
program instructions stored on the storage system that, executed by the processing system, direct the processing system to at least:
receive a uniform resource locator (URL);
in response to receiving the URL:
determine whether the URL is from a distrusted domain;
if the URL is from a distrusted domain, provide a misinformation notification;
if the URL is not from a distrusted domain, obtain text from content referenced by the URL and metadata associated with the URL, wherein the metadata associated with the URL comprises an author, a publisher, a date of publication, a headline, or a combination thereof;
determine whether the URL is a previously received URL;
if the URL is a previously received URL, provide cached information of the previously received URL from a data resource;
if the URL is not a previously received URL, determine whether the content referenced by the URL is a duplicate content;
if the content referenced by the URL is the duplicate content, provide cached information of the duplicate content from the data resource;
if the content referenced by the URL is not the duplicate content, perform a misinformation probability analysis of the URL, the obtained text, and the metadata associated with the URL using a feature set at a misinformation probability service, the feature set comprising semantic-based features and syntactic-based features;
receive, from the misinformation probability service, a probability value representing a misinformation confidence for the URL based on the performed misinformation probability analysis;
determine a misinformation result based on the probability value;
store the misinformation result in the data resource associated with the URL and corresponding content for the URL; and
provide the misinformation result.

12. The system of claim 11, wherein the receiving of the URL is in response to sharing the URL in social media, sharing the URL in an email message, providing search results, or receiving a request for misinformation detection, the request comprising the URL.

13. The system of claim 11, wherein the program instructions that direct the processor to determine of whether the URL is from a distrusted domain further direct the processor to query a whitelist of domains, a blacklist of domains, or both a whitelist of domains and a blacklist of domains for a domain of the URL.

14. The system of claim 11, wherein the program instructions that direct the processor to determine whether the URL is a previously received URL further direct the processor to query the data resource for the URL, wherein the data resource comprises a hash table, and wherein the program instructions that direct the processor to determine whether the content referenced by the URL is the duplicate content further direct the processor to perform a fuzzy hash on the obtained text from the content referenced by the URL.

15. The system of claim 11, wherein the semantic-based features and the syntactic-based features are selected from a group consisting of: sentiment amplifiers, sentiment continuity disruption features, lexical features, keywords, baseline features, sensicon features, speech act, emotion detection on the obtained text, exaggerated language, strong adjectives, heuristics, bag-of-words, objectivity, colloquial-ness score, and semantic difference.

16. The system of claim 15, wherein the feature set further comprises external link counts, user trust scores, user voting, or a combination thereof.

17. The system of claim 11, wherein the misinformation probability service is a machine learning service or a hybrid intelligence service.

18. The system of claim 11, wherein the program instructions that direct the processor to determine the misinformation result based on the probability value further direct the processor to assign a misinformation confidence level to the content referenced by the URL based on the probability value, wherein the misinformation confidence level is a high confidence level, a medium confidence level, or a low confidence level.

19. The system of claim 11, wherein the program instructions that direct the processor to determine the misinformation result based on the probability value further direct the processor to assign a misinformation category to the content referenced by the URL based on at least the probability value.

20. A computer readable storage medium having instructions stored therein that, when executed by a processor, perform a method comprising:
applying a syntactic analysis and a semantic analysis to detect misinformation with confidence by:
applying featurization to a URL, text of content referenced by the URL, and metadata associated with the URL using a feature set, the feature set comprising semantic-based features and syntactic-based features, wherein the semantic features and the syntactic features are selected from the group consisting of: sentiment amplifiers, sentiment continuity disruption features, lexical features, keywords, baseline features, sensicon features, speech act, emotion detection on the obtained text, exaggerated language, strong adjectives, heuristics, bag-of-words, objectivity, colloquial-ness score, and semantic difference.
